(19) United States
(12) Patent Application Publication
(10) Pub. No.: US 2005/0190172 A1
(43) Pub. Date: Sep. 1, 2005

(54) Voltage adjustment of opposing electrodes input in liquid crystal panel

(75) Inventor: Fumio Koyama, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/046,245

(22) Filed: Jan. 31, 2005

(30) Foreign Application Priority Data
Feb. 3, 2004 (JP) 2004-026913

(51) Int. Cl. G09G 5/00

(52) U.S. Cl. 345/204

(57) ABSTRACT

An opposing electrode voltage regulator adjusts the voltage values of an opposing electrode inputted in a liquid crystal display through the below processing. In a case where an instruction is given to adjust the voltage value of the opposing electrode inputted in the liquid crystal panel, the value of the parameter set to the opposing electrode voltage generator is changed, and a plurality of values are successively set. The difference between the maximum and minimum values of the luminance signal inputted from the luminance detectors is found as the flicker value for each parameter value. The parameter value corresponding to the minimum flicker value that was found is set to the opposing electrode voltage generator. The opposing electrode voltage is thereby adjusted in response to changes in the optimal value that should be provided as the opposing electrode voltage for the liquid crystal panel.

### BACKGROUND OF THE INVENTION

1. Field of the Invention

The present invention relates to technology for handling changes in the optimal voltage value that should be provided to opposing electrodes in a liquid crystal panel used in an image display device such as a projector.

2. Description of the Related Art

Liquid crystal panels are often used as optoelectronic devices for forming images. The liquid crystal device is an optoelectronic device that is capable of forming images by applying a voltage in response to an image signal corresponding to a pixel to liquid crystal forming the pixel and controlling the transmissivity of light radiated on the pixel.

FIGS. 4(A) and (B) are explanatory views showing an equivalent circuit of an arbitrary first pixel in a liquid crystal panel, and the waveform of voltage applied to the first pixel. As shown in FIG. 4(A), the first pixel PE is provided at an orthogonal intersection of a scan line SL and a signal line DL via a TFT (thin film transistor) 142, which is a switching element. A gate electrode for the TFT 142 (hereinafter, referred to as a “TFT switch”) is connected to the scan line SL, a drain electrode is connected to the signal line DL, and a source electrode is connected to a pixel electrode 144 of the pixel PE. An opposing electrode 146 opposing the pixel electrode 144 is connected to an opposing electrode signal line LCCOM, and an opposing electrode voltage Vcom with nearly the same potential is applied to the opposing electrode 146 of each pixel through the opposing electrode signal line LCCOM. Hereinafter, the opposing electrode voltage Vcom applied through the opposing electrode signal line LCCOM is called the LCCOM voltage.

Liquid crystal is held narrowly between the pixel electrode 144 and the opposing electrode 146. Equivalently, this liquid crystal is considered to be a capacitor (hereinafter, referred to as “liquid crystal capacitor”) CLC. Also, a storage capacitor Cs is added in parallel with the liquid crystal capacitor CLC. The combined capacitance Cpe of the liquid crystal capacitor CLC and the storage capacitor Cs (=CLC·Cs/(CLC+Cs)) is referred to as the “pixel capacitance”.

Of the image signal voltage Vo supplied by the signal line DL, the pixel signal voltage Vop corresponding to this pixel is written to the pixel capacitor Cpe through the TFT switch 142 which is turned “on” and “off” by a switch voltage Vg of a scan line drive signal supplied by the scan line SL. In detail, the image signal voltage Vop is written to the pixel capacitor Cpe as a pixel electrode voltage Vp during a sampling interval Ts, and the pixel electrode voltage Vp is saved in a hold interval Th as shown in FIG. 4(B). As a result, the liquid crystal on the pixel electrode 144 operates due to the potential difference between the LCCOM voltage Vcom supplied to the opposing electrode 146 and the pixel electrode voltage Vp supplied to the pixel electrode 144. A plurality of other pixels arranged in a matrix form are similar.

When a long interval direct current (DC) voltage is applied to the liquid crystal, a change occurs in the physical properties of the material due to polarization caused by impurity ions in the liquid crystal part, resulting in degradation phenomena such as a decrease in the resistance rate. An example of such a degradation phenomenon is the occurrence of a problem where traces of an image display remain, the so-called image burning.

To solve this problem, an alternative current drive is conventionally used for the pixels (that is, the liquid crystal). In further detail, the polarity of a pixel electrode voltage Vp applied to the pixel electrode 144 is made opposite to the LCCOM voltage Vcom applied to the opposing electrode 146 for each frame scan cycle, the average voltage applied to the pixel electrode 144 and the opposing electrode 146 is set to 0 V, and driving is carried out such that a DV voltage is not applied to the liquid crystal as shown in FIG. 4(B). In the polarity reversal, the 0 level was conventionally made the boundary, and shifts were alternately made between the positive and negative poles, but in the present Specification, the boundary is not limited to the 0 level, but may be made a desired level and includes cases where shifting occurs between a high level and a low level. In this case, the high level may be called the positive electrode and the low level the negative electrode for convenience sake.

The actual pixel electrode voltage Vp differs from the pixel signal voltage Vop depending on the leakage current through the liquid crystal resistor, the length of the hold interval Th, the size of the pixel capacitor Cpe, the “off” current of the TFT switch 142, and the feedthrough that occurs when the TFT 142 is turned “on” due to the parasitic capacitor of the TFT switch 142. Because of this, the LCCOM voltage Vcom needs to be the voltage center of the pixel electrode voltage Vp, not the signal voltage center Vop of the pixel signal voltage Vop to set the average voltage applied to the pixel PE to 0 V.

Provisionally, it is known that if the average voltage of the LCCOM voltage Vcom applied to the pixel PE is not set to an optimal value such as 0 V but to a value differing therefrom, the voltage of the positive side and negative side become asymmetrical, and flickering effects increase as the alternating frequency (a frame frequency of ½) component cannot be eliminated by an alternating drive. Also, because a direct current voltage is effectively applied to the liquid crystal, image burning such as that described above occurs.

The actual LCCOM voltage Vcom is ordinarily optimally adjusted before shipping from the factory where the display device utilizing the liquid crystal display is assembled.

Examples of technology related to this sort of technology are such as that given in Japanese Patent Laid-Open Gazette No. 59-119328 and No. 2002-358056.

Not all of the illuminating light illuminating the liquid crystal panel enters each pixel electrode 144; a part thereof radiates on the TFT switch 142 as so-called stray light. It is known that the optimal value of the LCCOM voltage Vcom changes depending on the luminance of the stray light radiating on the TFT switch 142.

Also, the luminance of the light source lamp used as the source for the illuminating light that illuminates the liquid crystal panel decreases over time, causing the luminance of the stray light radiating on the TFT switch 142 to change over time.

As a result, the optimal value of the LCCOM voltage Vcom changes over time, the flickering increases, and the burning problem occurs more readily.

### SUMMARY OF THE INVENTION

It is an object of the present invention to provide technology to solve the problems with conventional technology, and to adjust the voltage provided as the opposing electrode voltage for a liquid crystal panel in response to a change in the optimal value that should be provided as the opposing electrode voltage of the liquid crystal panel.

In order to attain at least part of the above and the other related objects, the present invention is directed to a first projector that includes a liquid crystal panel and a projection optical system for projecting a resulting image corresponding to the modulated light output from the liquid crystal panel. The first projector further includes: an opposing electrode voltage adjustment circuit for adjusting a value of an opposing electrode voltage inputted into the liquid crystal panel. The opposing electrode voltage adjustment circuit includes: an opposing electrode voltage generator for generating the opposing electrode voltage in response to a set parameter value; an opposing electrode voltage regulator for setting the parameter value to the opposing electrode voltage generator; and a luminance detector for detecting a luminance of the modulated light output from the liquid crystal panel and inputting a luminance signal representing the detected luminance into the opposing electrode voltage regulator. In a case where an instruction is given for an adjustment of the value of the opposing electrode voltage inputted into the liquid crystal panel, the opposing electrode voltage regulator changes the parameter value to a plurality of values and successively sets them to the opposing electrode voltage generator, obtains a difference between a maximum value and a minimum value of luminance signals inputted from the luminance detector as a flicker value for each of the parameter values, and sets the parameter value corresponding to a minimum flicker value out of the flicker values obtained for each of the parameter values to the opposing electrode voltage generator, thereby adjusting the value of the opposing electrode voltage inputted into the liquid crystal panel.

In this manner, it is possible in the first projector to automatically adjust the opposing electrode voltage value such that the flicker value becomes minimal in a case where an instruction is given to adjust the opposing electrode voltage value inputted in the liquid crystal panel at a specified timing.

Thus, it is possible to automatically adjust the voltage provided as the opposing electrode voltage for the liquid crystal panel according to changes in the optimal value that is to be provided to the liquid crystal panel as an opposing electrode voltage.

In the first projector, it is preferable that the luminance detector includes a luminance sensor for detecting a luminance of the modulated light, and the luminance sensor is disposed on a light path of modulated light that do not enter the projection optical system but is output from the liquid crystal panel.

In this way, it is possible to adjust the opposing electrode volume in the projector without stopping the projection of ordinary images, for example, because the luminance sensor does not shield modulated light from entering the projection optical system.

The present invention is directed to a second projector that includes a plurality of liquid crystal panels, a combination optical system for combining a plurality of modulated lights output from the plurality of liquid crystal panels, and a projection optical system for projecting a resulting image corresponding to the combined light output from the combination optical system. The second projector further includes: an opposing electrode voltage adjustment circuit for adjusting respective values of opposing electrode voltage inputted to the liquid crystal panels. The opposing electrode voltage adjustment circuit includes: a plurality of opposing electrode voltage generators for generating the opposing electrode voltage in response to a set parameter value, provided for each of the liquid crystal panels; an opposing electrode voltage regulator for setting the parameter value to each of the opposing electrode voltage generators; and a luminance detector for detecting a luminance of the combined light output from the combination optical system and inputting a luminance signal representing a detected luminance into the opposing electrode voltage regulator. In a case where an instruction is given to adjust respective values of opposing electrode voltage inputted to the liquid crystal panels, the opposing electrode voltage regulator selects only one of the plurality of liquid crystal panels, output the modulated light from the selected liquid crystal panel, changes the parameter value to a plurality of values and successively sets them to the opposing electrode voltage generator corresponding to the selected liquid crystal panel, obtains a difference between a maximum value and a minimum value of luminance signals inputted from the luminance detector as a flicker value for each of the parameter values, and sets the parameter value corresponding to a minimum flicker value out of the flicker values obtained for each of the parameter values to the corresponding opposing electrode voltage generator, thereby adjusting the value of the opposing electrode voltage inputted into the selected liquid crystal panel.

In this manner, in a case where an instruction is given to adjust opposing electrode voltage values inputted to the liquid crystal panels at a specified timing, it is possible with the second projector to automatically adjust the opposing electrode voltage value inputted in the selected liquid crystal panel such that the flicker value in the selected liquid crystal panel is minimal, so the opposing electrode voltage values inputted to the liquid crystal panels can all be automatically adjusted by selecting the plurality of liquid crystal panels in succession, for example.

Thus, it is possible to automatically adjust the voltage values provided as opposing electrode voltages to the liquid crystal panels in response to changes in the optimal value that is to be provided to the liquid crystal panels as the opposing electrode voltages.

In the second projector, it is preferable that the luminance detector includes a luminance sensor for detecting a luminance of the combination light, and the luminance sensor is disposed on a light path of combination light that do not enter the projection optical system but is output from the combination optical system. Because the luminance sensor does not shield the combined light entering the projection optical system, it is therefore possible to adjust the opposing electrode voltage in the projector without stopping the projection of ordinary images, for example.

The present invention is not limited to the projectors as modes, but may be effectuated in a variety of modes such as a mode as an opposing electrode voltage adjustment circuit, a mode as a liquid crystal display device equipped with such an opposing electrode voltage adjustment circuit, and a mode as a method invention such as an opposing electrode voltage adjustment method.

### BRIEF DESCRIPTION OF THE DRAWINGS

FIG. 1 is a block view showing the essential construction of a liquid crystal projector as one embodiment of the present invention.

FIG. 2 is a flowchart showing the procedure for LCCOM voltage adjustment

FIGS. 3(A) and (B) are explanatory views showing the placement of the luminance sensor 250 in a three-panel liquid crystal projector.

FIGS. 4(A) and (B) are explanatory views showing the waveform of voltage applied to an arbitrary pixel and an equivalent circuit of the pixel in a liquid crystal panel.

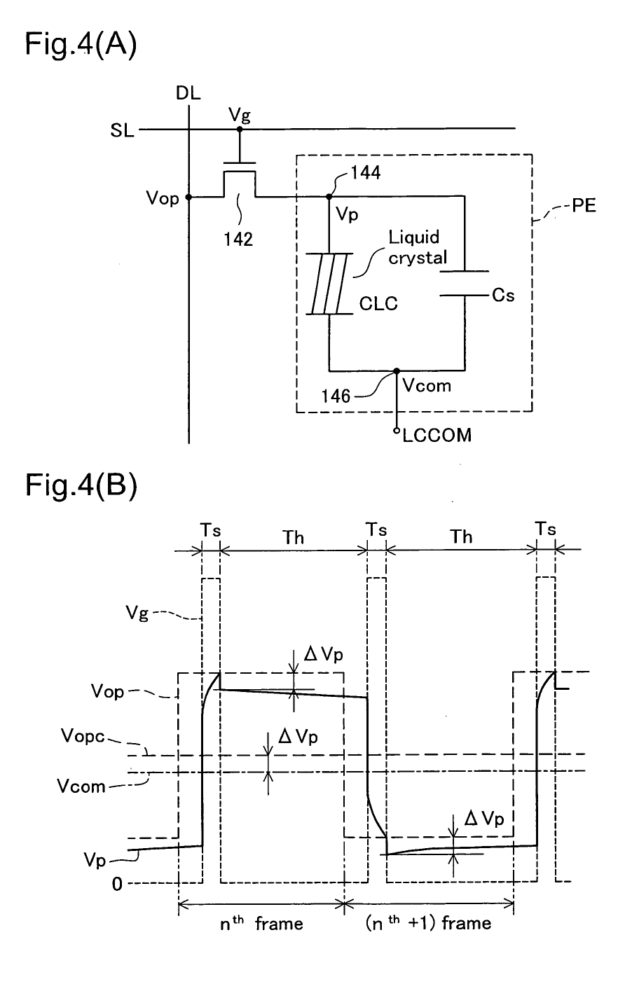

### DESCRIPTION OF THE PREFERRED EMBODIMENTS

Modes for working the present invention are described based on an embodiment in the following order:
A. The basic construction of a projector,
B. A LCCOM voltage regulation circuit,
C. A LCCOM voltage regulator,
D. Effects, and
E. Variation
   A. The Basic Construction of a Projector;

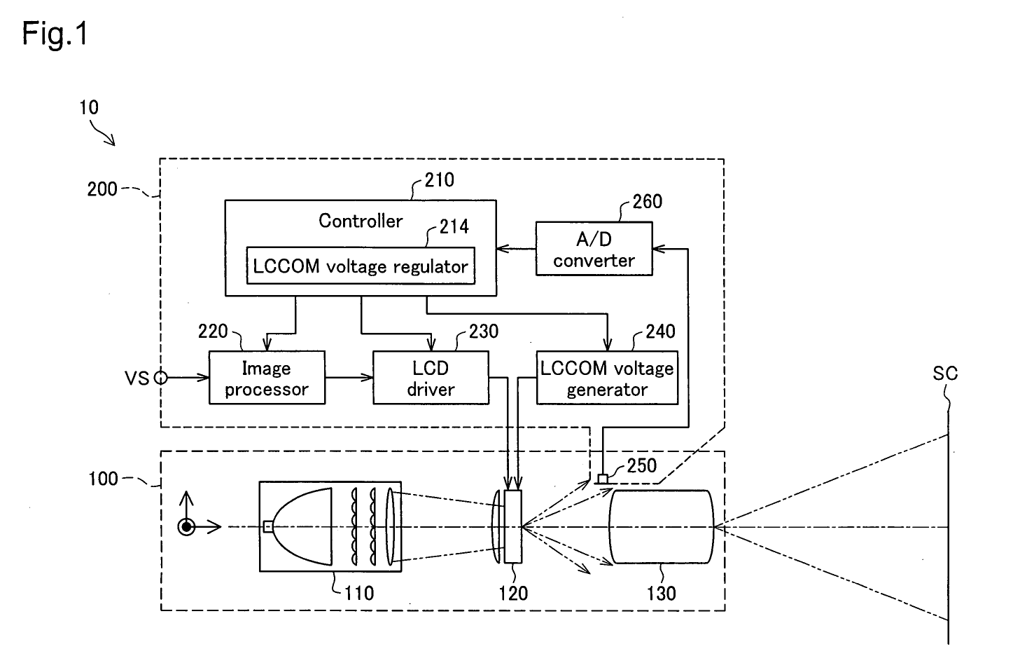

FIG. 1 is a block view showing the essential construction of a liquid crystal projector as one embodiment of the present invention. This liquid crystal projector 10 is composed of an optical system 100 for projecting images, and a control system 200 for controlling the photographing of images. The optical system 100 is equipped with an illumination optical system 110, a liquid crystal panel (LCD) 120, and a projection optical system 130. The control system 200 is equipped with a controller 210, an image processor 220, a liquid crystal panel (LCD) driver 230, a LCCOM voltage generator 240, a luminance sensor 250, and an A/D converter 260.

The controller 210 is composed of a computer equipped with a memory and CPU, not illustrated. The controller 210 reads and executes a program stored in the memory to control an image processor 220, an LCD driver 230, and an LCCOM voltage generator 240. For example, it controls the overall operation of the projector by setting to registers, not illustrated, the various parameter values used by the image processor 220, the LCD driver 230, and the LCCOM voltage generator 240 and controlling their respective operations.

The image processor 220 effectuates a variety of functions, namely analog digital conversion and decoding functions, a synchronous signal separation function, and an image processing function. That is, the image processor 220 internally converts inputted analog and digital image signals VS to usable digital image data, and synchronizes and writes the converted digital image data to a frame memory, not illustrated, or reads digital image data written to the frame memory. The image processor 220 also carries out image processing in the read and write process. A variety of image processing is possible such as luminance adjustment, color balance adjustment, contrast adjustment, sharpness adjustment and other image quality adjustments, image size magnification and reduction, and trapezoidal distortion correction.

The liquid crystal panel driver 230 generates a drive signal for driving the liquid crystal panel 120 based on image data inputted from the image processor 220. The generated drive signal is inputted to a terminal for inputting drive signals from the liquid crystal panel 120.

The LCCOM voltage generator 240 generates a voltage (hereinafter, referred to as the “LCCOM voltage”) that is applied to common opposing electrodes of the liquid crystal panel 120 based on the parameter values set to the resister, not illustrated, by the controller 220. The generated LCCOM voltage is inputted to the terminal (hereinafter, referred to as the “LCCOM input terminal”) for inputting the LCCOM voltage from the liquid crystal 120.

The liquid crystal panel 120 modulates illumination light output from the illumination optical system 110 based on drive signals from the liquid crystal driver 230 and the LCCOM voltage from the LCCOM voltage generator 240. The modulated light is output towards the projection optical system 130. That is, the liquid crystal panel 120 is transparent, and is used as a light valve (light modulator) for modulating illumination light.

The projection optical system 130 projects the modulation light radiated in the projection optical system 130 that was modulated by the liquid crystal panel 120 on a screen SC.

B. A LCCOM Voltage Regulation Circuit

The controller 210 functions as the LCCOM voltage regulator 214 when the CPU reads and executes the program stored in the memory. The LCCOM voltage regulator 214, the LCCOM voltage generator 240, the A/D converter 260 and the luminance sensor 250 as the luminance detector function as an LCCOM voltage regulation circuit, a characteristic of the present invention.

The luminance sensor 250 detects the luminance of modulated light output from the liquid crystal panel 120, and detects the luminance of entered light, outputting it as an analog luminance signal.

The A/D converter 260 converts the luminance signal inputted by the luminance sensor 250 to digital luminance data that can be inputted to the controller 210.

The LCCOM voltage regulator 214 uses the luminance data inputted from the A/D converter 260 for LCCOM voltage adjustment described below.

The luminance sensor 250 is disposed as described below in the present embodiment. In FIG. 1, the top side on the paper (+y direction) is the top of the elements 110, 120, and 130 in the optical system 100, and the elements 110, 120, and 130 are disposed along the horizontal direction (x direction) of the paper; the description of the elements 110, 120, and 130 is given from the size (+z direction).

As shown in FIG. 1, it is preferable if the luminance sensor 250 is disposed in a position such as to shield the modulated light output from the liquid crystal panel 120 that was radiated on the projection optical system 130, and to obtain a quantity of light such that a change in the luminance generated by flickering contained in the modulated light is detected. In the present embodiment, the luminance sensor 250 is disposed proximate to the projection optical system 130 and proximate to the outer edge on the top (the +y direction) of the projection optical system 130.

C. LCCOM Voltage Adjustment:

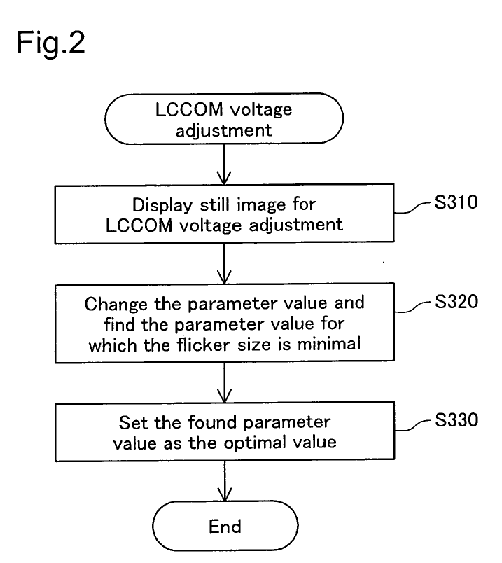

FIG. 2 is a flowchart showing the procedure for LCCOM voltage adjustment. LCCOM voltage adjustment is carried out at set timer intervals to correspond with temporal changes in the optimal value of the LCCOM voltage. In detail, the execution of a timer, not illustrated, of the controller 210 is triggered by an instruction to the LCCOM voltage regulator 214 to execute LCCOM voltage adjustment at fixed intervals. The fixed time intervals may be set as appropriate according to temporal changes.

When the LCCOM voltage adjustment processing begins, first, the LCCOM voltage regulator 214 causes the display of a still image for LCCOM voltage adjustment in step S310. In detail, image data showing the still image for LCCOM voltage adjustment is read from a memory not illustrated and inputted to the image processor 220 to carry out display of the still image for LCCOM voltage adjustment. A halftone solid image with a 50% luminance, for example, may be used as the still image for LCCOM voltage adjustment in which flickering can be readily detected.

Next, the LCCOM voltage regulator 214 finds a parameter value corresponding to the LCCOM voltage Vcom with the minimum flicker in step S320.

For example, the LCCOM voltage Vcom is sequentially changed in unit step intervals Vstp from the minimum value to the maximum value by changing and setting the parameter value for the LCCOM voltage generator 240 from the lowest possible value to the maximum value sequentially in the minimum unit (for example, 1) of the parameter value. The minimum and maximum values in the luminance data for each LCCOM voltage Vcom inputted from the A/D converter 260 is found, and the difference between the minimum and maximum values that were found of the luminance data is made the flicker size. It is thereby possible to find the parameter value corresponding to the LCCOM voltage Vcom set when the minimum flicker is found out of the flicker sizes that were found.

The frequency of the flicker is ordinarily equivalent to the alternating frequency (½ of the alternating drive frequency) when the liquid crystal is alternately driven. In the present embodiment, when the liquid crystal is alternately driven synchronized to a frequency of 60 Hz, the flicker frequency becomes half of the frame frequency, or 30 Hz. In order to make it possible to find the flicker in the luminance signal detected by the luminance sensor 250 with a high precision from the luminance data outputted from the A/D converter 260, sampling of the luminance signal is required at a high sampling rate at or above the Nyquist frequency in the A/D converter 260. That is, sampling is required at a sampling frequency at or about twice (60 Hz) the flicker frequency (30 Hz), and preferably, sampling is required at a sampling frequency 10 times or higher than the flicker frequency, and even more preferably, sampling is required at a sampling rate 100 times or more thereof. In the present embodiment, the luminance signal detected by the luminance sensor 250 is therefore sampled at a sampling frequency of 3 kHz, which is 100 times the flicker frequency (30 Hz) in the A/D converter 260.

Next, in step S330, the parameter value that is found is set as the optimal value, and is set to the LCCOM voltage generator 240. The LCCOM voltage generator 240 thereby outputs the optimal value of the LCCOM voltage Vcom, which is inputted to an LCCOM input terminal of the liquid crystal panel 120. The optimal value of the parameter that is found is stored in a nonvolatile memory, not illustrated. This optimal value is then used as the parameter value to be set to the LCCOM voltage generator 240 for initial set-up of the projector, such as when starting or resetting the projector.

D. Effects:

As described above, the projector 10 of the present embodiment operates an LCCOM voltage adjustment circuit, making it possible to automatically adjust the LCCOM voltage setting value to an optimal value such that the size of the flicker decreases.

Also, when the optimal value of the LCCOM voltage changes, for example, in cases where the luminance of the illumination light drops over time along with a temporal drop in luminance of the light source lamp composing the illumination optical system so the optimal value of the LCCOM voltage changes, the LCCOM voltage can be automatically adjusted to the optimal value according to temporal changes therein. It is thus possible to automatically control flickering that occurs in response to changes over time of the optimal value of the LCCOM voltage.

E. Modifications

The above embodiment is to be considered in all aspects as illustrative and not restrictive. There may be many modifications, changes, and alterations without departing from the scope or spirit of the main characteristics of the present invention.

E1. Modification 1:

LCCOM voltage adjustment in the embodiment described above is explained with an example where the LCCOM voltage adjustment is carried out at fixed time intervals, though it is not limited thereto. For example, in a case where the power button to the projector is operated by a user to begin projector shut-down processing, the adjustment may be carried out during the interval up until when the power is actually turned off. Also, the LCCOM voltage adjustment may be carried out according to user instructions. In this case, the user operates a remote controller not illustrated or an operation button provided on the projector unit, instructing the LCCOM voltage regulator 214 to carry out LCCOM voltage adjustment processing, so the processing is carried out. Also, the LCCOM voltage adjustment may be carried out not at one of the adjustment timings, but at a plurality of adjustment timings.

E2. Modification 2:

In the embodiment, the parameter value set to the LCCOM voltage generator 240 was successively changed and set in the LCCOM voltage adjustment processing from the minimum to the maximum value in the minimum settable units, thereby finding the size of the flicker in the LCCOM voltage Vcom, changed in unit step intervals Vstp, and then finding the parameter value corresponding to the LCCOM voltage Vcom whose flicker size is minimal; but the present invention is not limited thereto. For example, the change can be made not successively in unit step intervals Vstp but successively in step intervals coarser than the unit step interval Vstp, the step interval found estimated to include the LCCOM voltage Vcom with the minimum flicker, and the step interval changed in unit step intervals Vstp. In further detail, any adjustment method with which the value of the LCCOM voltage Vcom is changed by changing the parameter value of the LCCOM voltage generator 240 so the optimal value of the LCCOM voltage Vcom can be found with the minimum flicker size, and the parameter value corresponding thereto can be found as the optimal value, may be used.

E3. Modification 3:

In the embodiment described above, a case where the luminance sensor 250 is disposed proximate to the projection optical system 130 and at the outer edge on the projection optical system 130 was described as an example, but the invention is not limited thereto. For example, the luminance sensor 250 may be disposed proximate to the projection optical system 130 and at the outer edge under the projection optical system 130. It may also be disposed proximate to the projection optical system 130 and at the outer edge to the left or the right of the projection optical system 130. It may also be disposed proximate to the liquid crystal panel 120. In further detail, it may be disposed at any position as long as light not entering the projection optical system 130 can be detected such that the modulated light entering the projection optical system 130 is not shielded. Also, a plurality of luminance sensor may be disposed in a plurality of locations.

E4. Modification 4:

In the embodiment described above, a case where the luminance sensor 250 was disposed such that modulated light entering the projection optical system 130 is not shielded was described as an example, but it may be disposed such that the luminance of the modulated light entering the projection optical system 310 is detected. In this case, however, it is favorable to dispose it in the light path between the liquid crystal panel 120 and the projection optical system 130 in a position where the luminance sensor 250 is not formed as the projection image, that is proximate to the projection optical system 130. In a case where it is thus disposed, the image may become dark, but it is possible to detect the flicker of light actually projected, which is advantageous for adjustment.

If the luminance sensor 250 is equipped with a mechanism to move the luminance of the modulated light entering the projection optical system 130 to a detectable position only during LCCOM voltage adjustment, an ordinary image can be prevented from becoming dark if the image is projected when not during an LCCOM voltage adjustment.

E5. Modification 5:

In the embodiment described above and the modifications 3 and 4, a case was described where the luminance of modulated light output from the liquid crystal panel 120 is detected, but the luminance of the projection light output from the projection optical system 130 may be detected as well.

E6. Modification 6:

In the embodiment described above, a case was described where the present invention is applied to a single-panel liquid crystal projector that uses one liquid crystal panel, but the present invention may be applied to liquid crystal projectors that have three or any other number of liquid crystal panels as well.

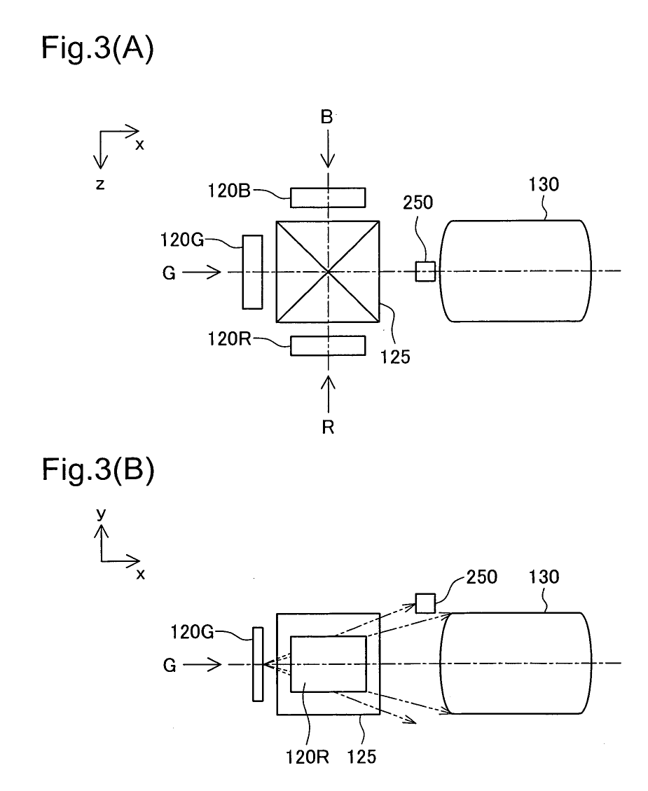

FIGS. 3(A) and (B) are explanatory views showing the positional relationship of the luminance sensor 250 in a three-panel liquid crystal projector.

The three-panel liquid crystal projector is equipped with three liquid crystal panels 120R, 120G, and 120B for respectively modulating the entering red (R), green (G), and blue (B) light; a cross-dichroic prism 125 for combining the variously colored modulated light output from the liquid crystal panels 120R, 120G, and 120B; and the projection optical system 130 for projecting the combined light from the cross-dichroic prism 125.

FIG. 3(A) is an outline plan view of the optical elements as viewed from above. FIG. 3(B) is an outline plan of the optical elements in FIG. 3(A) as viewed from the right.

The luminance sensor 250 is disposed between the cross-dichroic prism 125 and the projection optical system 130. In further detail, the luminance sensor 250 is disposed proximate to the projection optical system 130 and at the outer edge above the projection optical system 130 similar to in the embodiment such that the modulated light output from the liquid crystal panels 120R, 120G, and 120B and entering the projection optical system 130 is not shielded, and that the luminance can be detected whose change due to flicker can be adequately detected. The arrangement described in modification s 3 to 5 may be used.

Also, an image processor, LCD driver, and LCCOM voltage generator having the same functions as the image processor 220, the LCD driver 230, and the LCCOM voltage generator 240 are provided respectively at the liquid crystal panels 120R, 120G, and 120B.

LCCOM voltage adjustment is carried out separately at the liquid crystal panels 120R, 120G, and 120B. For example, for adjusting the LCCOM voltage of the liquid crystal panel 120R for R, modulated light output from the other liquid crystal panels 120G and 120B may be shielded to carry out the same LCCOM voltage adjustment processing as in the embodiment.

To shield modulated light output from the other liquid crystal panels, the gradation value of the color signals entering the liquid crystal panels can be set to a minimum level, so the output modulated light becomes only stray light as a rule.

E7. Modification 7:

In the embodiment mentioned above, a case where a halftone solid image with 50% luminance is used as a still image for adjustment in LCCOM voltage adjustment is described as an example, but the invention is not limited thereto; a still image with detectable flicker may also be used.

E8. Modification 8:

In the embodiment mentioned above, a still image for adjustment is displayed during LCCOM voltage adjustment. However, the invention is not limited thereto, and LCCOM voltage adjustment may be carried out when displaying an ordinary projection image.

Provisionally, in the case where a moving image is displayed, luminance change caused by a change in the image in the moving image is included in the luminance change detected by the luminance sensor 250. In this case, the possibility that the detection precision of flicker will decrease is high.

In this case, whether the displayed image is a moving image or a still image may be determined during LCCOM voltage adjustment, and if it is a moving image, a still image for LCCOM voltage adjustment may be displayed.

E9. Modification 9:

In the embodiment described above, a projector using a liquid crystal panel is described as an example, but the invention is not limited thereto, but may be applied to a direct-view image display device using liquid crystal panels. In the case of a direct-view image display device, however, a projection optical system is not provided, so the luminance sensor is disposed proximate to the liquid crystal panels.

1. A projector that comprises a liquid crystal panel and a projection optical system for projecting a resulting image corresponding to the modulated light output from the liquid crystal panel, the projector further comprising:
an opposing electrode voltage adjustment circuit for adjusting a value of an opposing electrode voltage inputted into the liquid crystal panel,
wherein the opposing electrode voltage adjustment circuit comprises:
an opposing electrode voltage generator for generating the opposing electrode voltage in response to a set parameter value;
an opposing electrode voltage regulator for setting the parameter value to the opposing electrode voltage generator; and
a luminance detector for detecting a luminance of the modulated light output from the liquid crystal panel and inputting a luminance signal representing the detected luminance into the opposing electrode voltage regulator,
wherein in a case where an instruction is given for an adjustment of the value of the opposing electrode voltage inputted into the liquid crystal panel, the opposing electrode voltage regulator changes the parameter value to a plurality of values and successively sets them to the opposing electrode voltage generator, obtains a difference between a maximum value and a minimum value of luminance signals inputted from the luminance detector as a flicker value for each of the parameter values, and
sets the parameter value corresponding to a minimum flicker value out of the flicker values obtained for each of the parameter values to the opposing electrode voltage generator, thereby adjusting the value of the opposing electrode voltage inputted into the liquid crystal panel.

2. The projector in accordance with claim 1, wherein the luminance detector includes a luminance sensor for detecting a luminance of the modulated light, and
the luminance sensor is disposed on a light path of modulated light that do not enter the projection optical system but is output from the liquid crystal panel.

3. A projector that comprises a plurality of liquid crystal panels, a combination optical system for combining a plurality of modulated lights output from the plurality of liquid crystal panels, and a projection optical system for projecting a resulting image corresponding to the combined light output from the combination optical system, the projector further comprising:
an opposing electrode voltage adjustment circuit for adjusting respective values of opposing electrode voltage inputted to the liquid crystal panels,
wherein the opposing electrode voltage adjustment circuit comprises:
a plurality of opposing electrode voltage generators for generating the opposing electrode voltage in response to a set parameter value, provided for each of the liquid crystal panels;
an opposing electrode voltage regulator for setting the parameter value to each of the opposing electrode voltage generators; and
a luminance detector for detecting a luminance of the combined light output from the combination optical system and inputting a luminance signal representing a detected luminance into the opposing electrode voltage regulator,
wherein in a case where an instruction is given to adjust respective values of opposing electrode voltage inputted to the liquid crystal panels, the opposing electrode voltage regulator selects only one of the plurality of liquid crystal panels, output the modulated light from the selected liquid crystal panel, changes the parameter value to a plurality of values and successively sets them to the opposing electrode voltage generator corresponding to the selected liquid crystal panel, obtains a difference between a maximum value and a minimum value of luminance signals inputted from the luminance detector as a flicker value for each of the parameter values, and
sets the parameter value corresponding to a minimum flicker value out of the flicker values obtained for each of the parameter values to the corresponding opposing electrode voltage generator, thereby adjusting the value of the opposing electrode voltage inputted into the selected liquid crystal panel.

4. The projector in accordance with claim 3, wherein the luminance detector includes a luminance sensor for detecting a luminance of the combination light, and
the luminance sensor is disposed on a light path of combination light that do not enter the projection optical system but is output from the combination optical system.

5. An opposing electrode voltage adjustment circuit for adjusting a value of an opposing electrode voltage inputted into the liquid crystal panel, the opposing electrode voltage adjustment circuit comprising:
an opposing electrode voltage generator for generating the opposing electrode voltage in response to a set parameter value;
an opposing electrode voltage regulator for setting the parameter value to the opposing electrode voltage generator; and
a luminance detector for detecting a luminance of the modulated light output from the liquid crystal panel and inputting a luminance signal representing the detected luminance into the opposing electrode voltage regulator,
wherein in a case where an instruction is given for an adjustment of the value of the opposing electrode voltage inputted into the liquid crystal panel, the opposing electrode voltage regulator changes the parameter value to a plurality of values and successively sets them to the opposing electrode voltage generator, obtains a difference between a maximum value and a minimum value of luminance signals inputted from the luminance detector as a flicker value for each of the parameter values, and
sets the parameter value corresponding to a minimum flicker value out of the flicker values obtained for each of the parameter values to the opposing electrode voltage generator, thereby adjusting the value of the opposing electrode voltage inputted into the liquid crystal panel.

6. A liquid crystal device comprising the opposing electrode voltage adjustment circuit according to claim 5.
